(19) United States
(12) Patent Application Publication
(10) Pub. No.: US 2024/0028958 A1
(43) Pub. Date: Jan. 25, 2024

(54) METHOD, DEVICE, AND COMPUTER PROGRAM PRODUCT FOR PROCESSING REQUEST MESSAGE

(71) Applicant: Dell Products L.P., Round Rock, TX (US)

(72) Inventors: Jiacheng Ni, Shanghai (CN); Zijia Wang, Weifang (CN); Jinpeng Liu, Shanghai (CN)

(73) Assignee: Dell Products L.P., Round Rock, TX (US)

(21) Appl. No.: 18/223,624

(22) Filed: Jul. 19, 2023

(30) Foreign Application Priority Data
Jul. 22, 2022 (CN) 202210868963.8

(51) Int. Cl. G06N 20/00

(52) U.S. Cl. CPC G06N 20/00

(57) ABSTRACT

Embodiments of the present disclosure relates to processing a request message. The method includes receiving a request message from a user, determining a text feature representation of the request message by using a trained text feature representation model, and determining one or more entries of reference knowledge associated with the request message in a knowledge base by using a trained reference recommendation model and based on the text feature representation. In the method, the text feature representation model is trained by using a general corpus and a set of historical request messages, and the reference recommendation model is trained by using a request message subset in the set of historical request messages that has been associated with the entries in the knowledge base.

### TECHNICAL FIELD

Embodiments of the present disclosure relate to the field of computers, and in particular, to a method, a device, and a computer program product for processing a request message.

### BACKGROUND

Among companies that provide large-scale and complex online services, a technical support engineer team will process a large number of client service request messages, involving problem reports caused by software defects, hardware or network problems, or errors in operation, and so on. Content of these request messages is diverse and needs to be processed in time to maintain good user experience. Therefore, a method is needed to intelligently assist technical support engineers in quickly and accurately processing client service request messages.

### SUMMARY OF THE INVENTION

Embodiments of the present disclosure provide a solution for processing a request message.

In a first aspect of the present disclosure, a method for processing a request message is provided and includes: receiving a request message from a user, wherein the request message describes a user request to be processed; determining a text feature representation of the request message by using a trained text feature representation model, wherein the text feature representation model is trained by using a general corpus and a set of historical request messages; and determining, based on the text feature representation, one or more entries associated with the request message in a knowledge base by using a trained reference recommendation model, wherein the knowledge base includes a plurality of entries of reference knowledge for processing user requests, the reference recommendation model is trained by using a subset of the set of historical request messages, and the request messages in the subset have been associated with the entries in the knowledge base.

In a second aspect of the present disclosure, an electronic device is provided and includes a processor and a memory coupled to the processor. The memory has instructions stored therein. The instructions, when executed by the processor, cause the device to execute actions which include: receiving a request message from a user, wherein the request message describes a user request to be processed; determining a text feature representation of the request message by using a trained text feature representation model, wherein the text feature representation model is trained by using a general corpus and a set of historical request messages; and determining, based on the text feature representation, one or more entries associated with the request message in a knowledge base by using a trained reference recommendation model, wherein the knowledge base includes a plurality of entries of reference knowledge for processing user requests, the reference recommendation model is trained by using a subset of the set of historical request messages, and the request messages in the subset have been associated with the entries in the knowledge base.

In a third aspect of the present disclosure, a computer program product is provided. The computer program product is tangibly stored on a computer-readable medium and includes machine-executable instructions. The machine-executable instructions, when executed, cause a machine to execute the method according to the first aspect of the present disclosure.

It should be noted that the Summary of the Invention part is provided to introduce a selection of concepts in a simplified manner, and these concepts will be further described in the Detailed Description below. The Summary of the Invention part is neither intended to identify key features or major features of content of the present disclosure, nor intended to limit the scope of the content of the present disclosure.

### BRIEF DESCRIPTION OF THE DRAWINGS

By further detailed description of example embodiments of the present disclosure with reference to the accompanying drawings, the above and other objectives, features, and advantages of the present disclosure will become more apparent, in which:

FIG. 1 shows a schematic diagram of an example environment in which a plurality of embodiments of the present disclosure can be implemented;

FIG. 2 shows a flow chart of a method for processing a request message according to some embodiments of the present disclosure;

FIG. 3 shows a flow chart of a method for training a text feature representation model according to some embodiments of the present disclosure;

FIG. 4 shows an example workflow for training a reference recommendation model according to some embodiments of the present disclosure; and

FIG. 5 shows a schematic block diagram of a device that may be configured to implement embodiments of the present disclosure.

Throughout all the drawings, the same or similar reference numerals represent the same or similar elements.

### DETAILED DESCRIPTION

The embodiments of the present disclosure will be described in more detail below with reference to the accompanying drawings. Although the drawings show some embodiments of the present disclosure, it should be understood that the present disclosure can be implemented in various forms, and should not be explained as being limited to the embodiments stated herein. Instead, these embodiments are provided for understanding the present disclosure more thoroughly and completely. It should be understood that the accompanying drawings and embodiments of the present disclosure are for illustrative purposes only, and are not intended to limit the protection scope of the present disclosure.

The term “include” and its variants as used herein mean open-ended inclusion, i.e., “including but not limited to.” The term “based on” is “based at least in part on.” The term “one embodiment” means “at least one embodiment.” The term “another embodiment” indicates “at least one additional embodiment.” Relevant definitions of other terms will be given in the description below.

In a client service system of many online service providers (such as information services, functional services, etc.), users can (for example, through a service request tracking and solving module) submit service request messages to the service providers, and these service request messages describe requests to be processed by the service providers. For example, the service request messages can describe problems that the users encounter while the users use services and need to be processed. After receiving the service request messages, support engineers need to process these requests (for example, repairing failures, providing operation sequences, etc.) in time to solve problems of the users, thereby maintaining good user experience.

However, due to the complexity of business scenarios, the problems involved in service requests may be ones that the engineers have never processed. In addition, due to the different levels of experience of the engineers, the time spent on processing the service requests may be largely different. In order to support the engineers (especially engineers with less experience) to process the service requests more efficiently, a client service center often provides a knowledge base that contains reference knowledge for processing requests for the engineers to look up and refer to entries that help to process a certain request while processing the request. The entries in the knowledge base may include a description of a solution process for a problem of a certain kind that may occur in the services and other reference materials (such as pictures). After solving the problem, the support engineers may also store, in an associated manner, the request messages that have been solved and the knowledge base entries that are referred to while the problem is solved, for example, by adding references and/or tags of the corresponding knowledge base entries to records (for example, logs or historical records in other forms) of the request messages. In addition, when new knowledge not contained in the knowledge base is involved while solving a problem, the engineers may also add a new entry to the knowledge base, and store the corresponding request message and the new entry in an associated manner.

However, service request messages often contain a combination of unstructured texts, such as client description, system logs, memory dump files, performance statistics, stack traces, and the like. There are differences in the expression of request messages of even similar problems. On the other hand, the knowledge base may include a large number of entries for problems of various kinds. This makes it difficult to efficiently find the reference knowledge in the knowledge base that helps to process a problem described in a specific service request message. Engineers may need to conduct a large number of searches and previews to find entries that include reference knowledge useful to process the service request.

To at least partially solve the above and other potential problems, embodiments of the present disclosure provide a solution for processing a request message. In the solution, when receiving a request message of a user, content of the request message is converted into a text feature representation by using a trained text feature representation model that has been adjusted for the request message. Then, the solution uses a reference recommendation model to identify an entry in a knowledge base that is most likely to be helpful to solve the request message according to the text feature. The reference recommendation model has been trained by using known historical request messages of associated knowledge base entries (for example, through tags of request records).

On this basis, the present disclosure further discloses a method for training the text feature representation model and the reference recommendation model. First, one or more unsupervised learning tasks are executed on the text feature representation model by using a corpus so that an initial text feature representation model is determined. Then, the initial model is further trained by using a set of available historical request messages, and the initial model is adjusted to be more suitable for representing the request message. The embodiment of the present disclosure may also select a message that already has associated knowledge base entries from the set of historical request messages to execute supervised training on the reference recommendation model, so that the reference recommendation model can recommend reference knowledge associated with the request message based on the text feature representation model of the request message. In some embodiments of the present disclosure, when a training task is executed on the reference model, the text feature representation model may be connected together with the reference recommendation model for training, and in this process, the text feature representation module may be also further fine-tuned.

By using the solution of the present disclosure, appropriate knowledge references can be automatically recommended to technical support engineers, who process user service requests, more accurately than using a universal model, so that the engineers can quickly obtain information that helps to process request content described in specific request messages. As a result, the efficiency of processing request message from users can be improved, and the satisfaction degree of the users can be maintained at a good level.

The following will describe the solution of the present disclosure in a scenario of user support of online services, but it should be understood that the solution of the present disclosure may also be applied to processing of request messages of other types (such as business consulting, workflow recommendation, etc.).

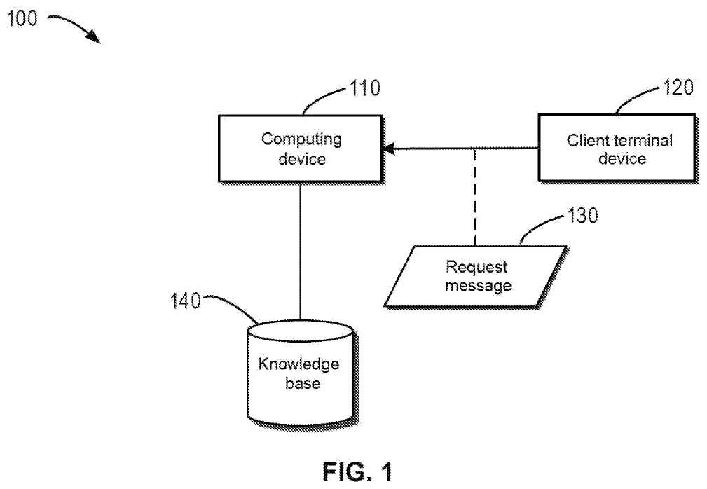

FIG. 1 shows a schematic diagram of example environment 100 in which a plurality of embodiments of the present disclosure can be implemented. Environment 100 may include computing device 110. Computing device 110 may be any fixed or mobile computing device with sufficient computing capacity to execute the method of the present disclosure. For example, computing device 110 may be a server of a client support center of a system or a service provider. In addition, although illustrated as a single device, computing device 110 may also be a plurality of devices, a virtual device, or any other form of devices suitable for implementing the embodiments of the present disclosure.

FIG. 1 also shows client terminal device 120. For example, client terminal device 120 may be a device of a user to be served. Client terminal device 120 can send request message 130 to computing device 110. For example, the user may submit request message 130 to computing device 110 through a client service request tracking and solving module installed on client terminal device 120.

Computing device 110 may, for example, receive request message 130 from client terminal device 120, and perform various operations based on the received request message. For example, computing device 110 may use the method of the present disclosure to identify one or more entries associated with request message 130 from knowledge base 140 shown in FIG. 1, add entries to knowledge base 140, store request message 130 and a certain entry in an associated manner (for example, based on user input), etc. It should be understood that computing device 110 may also transmit request messages and other messages with other client terminals not shown, and/or transmit messages different from request message 130 with client terminal 120.

Knowledge base 140 includes a plurality of entries, each of which includes reference knowledge for processing a user request. The reference knowledge may be in the form of text, pictures, videos, or links, or a combination of the foregoing forms or any other form used to convey knowledge information to human users. It should be understood that although it is shown as separate entities, knowledge base 140 and computing device 110 may also have other relationships. For example, knowledge base 140 may reside on computing device 110.

The architecture and functions in example environment 100 are described for illustrative purposes only, and do not imply any limitation to the scope of the present disclosure. There may also be other devices, systems, or components that are not shown in environment 100. Furthermore, the embodiments of the present disclosure may also be applied to other environments having different structures and/or functions.

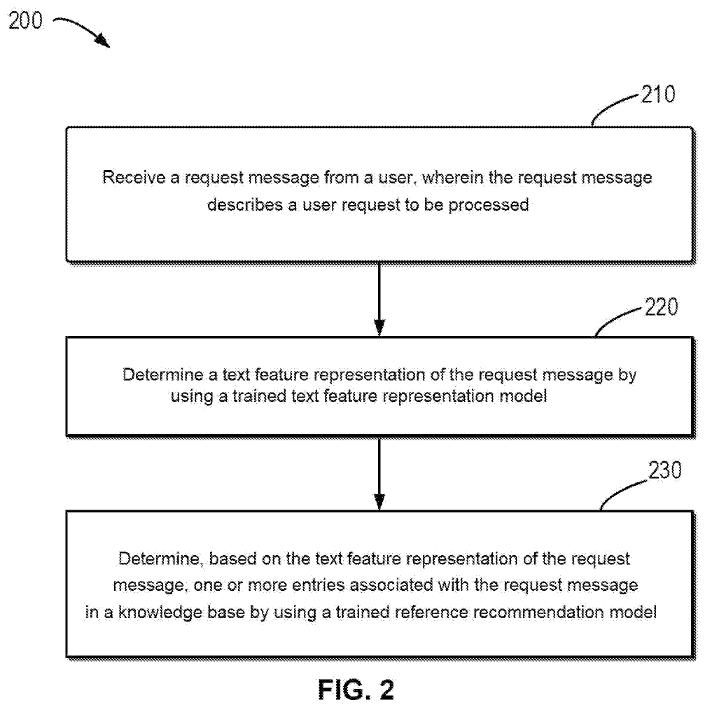

FIG. 2 shows a flow chart of example method 200 for processing a request message according to some embodiments of the present disclosure. For example, example method 200 may be executed by computing device 110 shown in FIG. 1. It should be understood that method 200 may also include additional actions not shown, and the scope of the present disclosure is not limited in this regard. Method 200 is described in detail below in conjunction with example environment 100 of FIG. 1.

At block 210, a request message is received from a user, wherein the request message describes a user request to be processed. For example, computing device 110 may receive request message 130 from a user from client terminal device 120. For example, request message 130 may describe a problem that the user encounters and needs to solve while the user uses a service of an information service provider that owns computing device 110 (such as a failure of an application of the service).

In some embodiments, request message 130 may be created via an application user interface (for example, a user interface of a service submission module) installed on client terminal device 120 and sent to computing device 110. In some embodiments, request message 130 may include a title (or abstract) and a detailed description regarding specific content of the request. Request message 130 may also have other text structures and/or be created and sent in other ways.

At block 220, a text feature representation of the request message is determined by using a trained text feature representation model, wherein the text feature representation model is trained by using a general corpus and a set of historical request messages. For example, computing device 110 may determine a text feature representation of request message 130 by using the trained text feature representation model, wherein the text feature representation model is trained by using a general corpus and a set of historical request messages.

In some embodiments, the general corpus may be a general corpus in a field associated with the request message, for example, a corpus extracted from Wiki of an information service or system at which the request message is directed and/or texts of a reference book, and the like. In some embodiments, the language used by the general corpus is the same as the language used by the request message whose representation is to be determined.

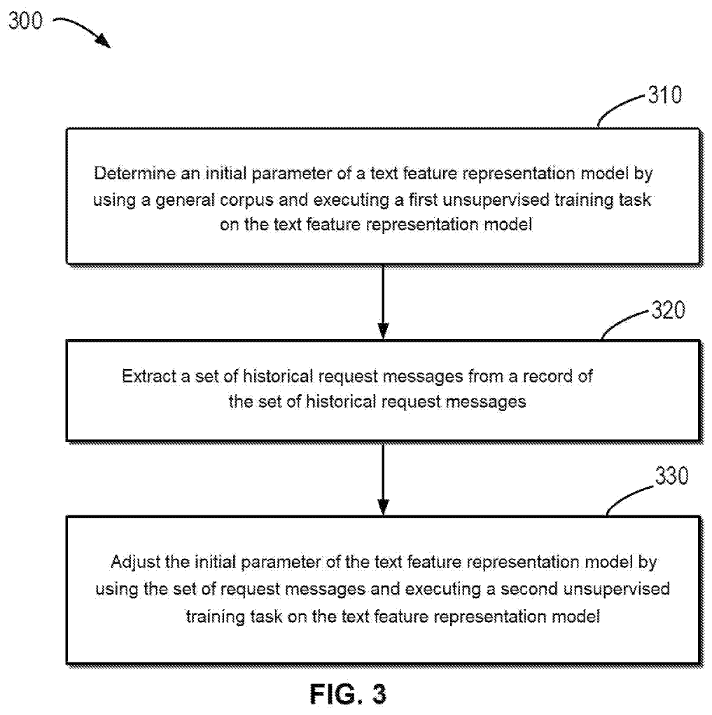

The text feature representation model herein can convert text (for example, unstructured) into a text feature representation suitable for machine analysis and processing, for example, encoding each character into an embedding vector. In some embodiments, computing device 110 may also train the text feature representation model before the text feature representation model is used at block 220. Training of the text feature representation model will be described in more detail below with reference to FIG. 3.

Now still refer to FIG. 2. At block 230, one or more entries associated with the request message in the knowledge base are determined based on the text feature representation of the request message by using the trained reference recommendation model, wherein the knowledge base includes a plurality of entries of reference knowledge for processing user requests. The reference recommendation model is trained by using a subset of the set of historical request messages. Request messages in the subset have been associated with the entries in the knowledge base.

For example, computing device 110 may determine one or more entries associated with request message 130 in knowledge base 140 based on the text feature representation of request message 130 determined at block 220 and by using the trained reference recommendation model. Knowledge base 140 includes a plurality of entries of reference knowledge for processing user requests. The reference recommendation model may have been trained by using a subset of the set of historical request messages used to train the text feature representation model (for example, as described at block 220), and the historical request messages in the subset have been associated with the entries in knowledge base 130 (for example, marked with tags corresponding to the entries).

In some embodiments, computing device 110 may determine the probability that an entry in the knowledge base is associated with request message 130 by using the reference recommendation model and recommend one or more entries therein with the highest probability of association with request message 130.

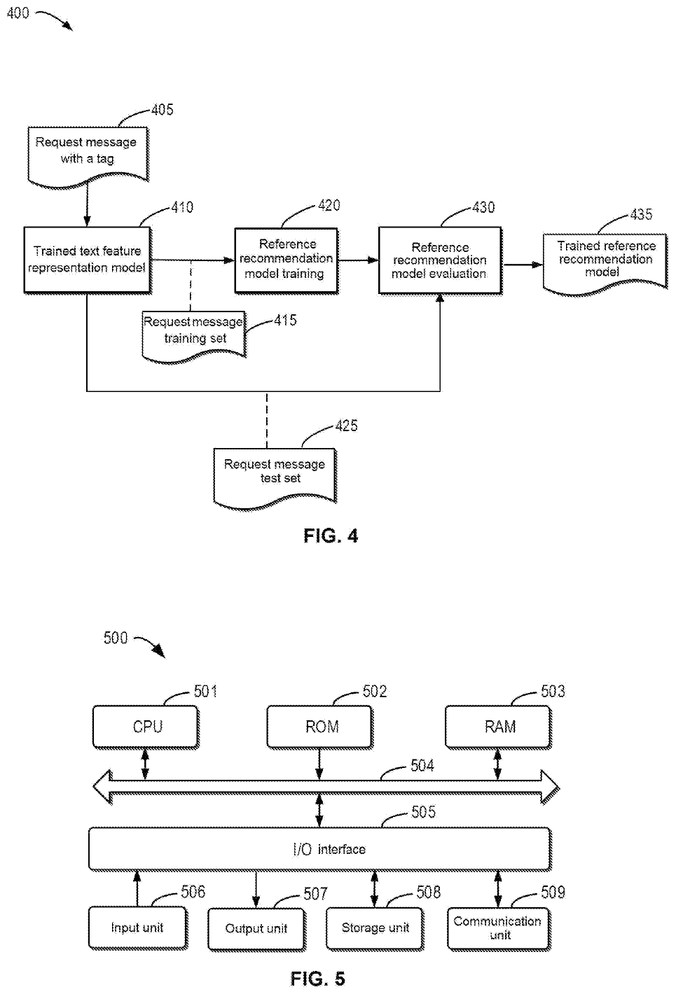

When being trained, the reference recommendation model may learn the association of historical request messages in the subset with entries in the knowledge base in conjunction with the text feature representation model, for determining an entry in the knowledge base that is associated with a specific request message. In some embodiments, computing device 110 may also train the reference recommendation model before the reference recommendation model is used at block 230. Training of the reference recommendation model will be described in more detail below with reference to FIG. 4.

By using method 200, computing device 110 can automatically recommend to the engineer processing the reference knowledge that is helpful in solving a transaction in the request message. Besides, the text feature representation on which the recommendation performed by the reference recommendation model is based is generated by the text feature representation model trained using both the general corpus and the historical request messages. Recommending reference knowledge according to method 200 can provide more accurate recommendation results than a method that is not adapted to a model in the relevant field of the request message.

In some embodiments, after determining one or more knowledge base entries associated with request message 130, for example, using method 200, computing device 110 may also present the determined one or more entries via a user interface. For example, computing device 110 may present, through a graphical user interface, information in the one or more entries, including but not limited to an entry's ID, title, abstract, content, or a link to its content. In this way, the engineer to process request message 130 can easily obtain the reference knowledge in the recommended entries.

In such embodiment, computing device 110 may also receive a selection for entries in the knowledge base through the user interface. For example, the engineer can select entries that are truly helpful to process request message 130 in the recommended one or more entries. For example, the engineer may also select other helpful entries found during processing of request message 130.

After receiving the selection, computing device 110 may also associate a record of request message 130 (for example, a log recording request message 130) with the selected entries, for example, by adding a tag and/or link indicating the selected entries to the record. Later, computing device 110 may use this record and its association with the entries in the knowledge base (for example, the added tag) to adjust the reference recommendation model. For example, computing device 140 may use it as part of training data to retrain the reference recommendation model (for example, through the method as described below with reference to FIG. 4) to improve the reference recommendation model.

In some embodiments, computing device 110 may also receive, via the user interface, a new entry that should be added to the knowledge base. For example, during processing of request message 130, the engineer may not find a knowledge base entry that facilitates the processing of request message 130. In this case, the engineer can create a new entry via the user interface. For example, the new entry includes a description of a processing process of request message 130). Similar to the foregoing, after receiving the new entry, computing device 110 may also associate the record of request message 130 with the new entry, and may use the record and its association with the new entry to adjust the reference recommendation model.

FIG. 3 shows a flow chart of example method 300 for training a text feature representation model according to some embodiments of the present disclosure. Example method 300 may be executed by, for example, computing device 110 shown in FIG. 1, and the trained text feature representation model may be used, for example, at block 220 of method 200. It should be understood that some actions in method 300 may be omitted, method 300 may further include additional actions not shown, and the scope of the present disclosure is not limited in this regard. Method 300 is described in detail below in conjunction with example environment 100 of FIG. 1.

At block 310, computing device 110 may determine an initial parameter of the text feature representation model by using the general corpus (for example, the above corpus extracted from Wiki and/or reference book) and executing a first unsupervised training task on the text feature representation model.

In some embodiments, computing device 110 may construct the text feature representation model based on a common text representation model structure in a natural language processing technology (for example, bidirectional encoder representations (BERT) based on an encoder and various variants thereof, such as RoBERTa). The model constructed in this way can convert natural language text into a form suitable for machine processing, for example, converting a lemma of the text into a corresponding feature vector for embedding.

On this basis, computing device 110 may pre-train the text feature representation model by using the general corpus to determine the initial parameter of the text feature representation model. In some embodiments, computing device 110 may execute the pre-training by using the general corpus as training data to execute one or more unsupervised learning tasks. For example, computing device 110 may determine the initial parameter of the text feature representation model by using one or more items in a masked language model (MLM) task and a next-sentence prediction (NSP) task as pre-training tasks. For example, on the basis of RoBERTa, computing device 110 may use dynamic MLM as a training task to construct a model without using NSP. In the dynamic MLM task, computing device 110 may dynamically generate different mask modes every time an input text sequence for training is provided to the model to mask off part of the input sequence so as for predicting the masked part by the model under training. Computing device 110 may also use other known or future-developed unsupervised learning tasks to execute pre-training.

At block 320, computing device 110 may extract a set of historical request messages from a record of the set of historical request messages. For example, computing device 110 can extract text of a historical request message including the title and specific description. In some embodiments, computing device 110 may record the received request message in a log, and extract a set of historical request messages from the recorded log. In some other embodiments, computing device 110 may also obtain a record of a set of historical request messages and extract messages in other ways.

In some embodiments, computing device 110 may also pre-process the extracted historical request messages, so that the historical request messages can be used as an input to the text feature representation model. For example, computing device 110 may connect text of various parts (for example, the title and description) of the messages, adjust cases of the text of the request messages (for example, the text is uniformly converted into lowercase letters, etc.), remove punctuations and stop words and other noise, etc. In some embodiments, when the trained model is later used, these pre-processing functions may be implemented as a pre-processing layer connected with the trained model, so that the request messages received by computing device 110 can be directly converted into text feature representations automatically.

At block 330, computing device 110 may adjust the initial parameter of the text feature representation model by using the set of historical request messages extracted at block 320 and executing a second unsupervised training task on the text feature representation model. In this way, computing device 110 can obtain the trained text feature representation model. In some embodiments, computing device 110 may further adjust the pre-trained text feature representation model by using a set of request messages (for example, pre-processed) as training data. In this process, the initial parameter of the text feature representation model is adjusted, so that the model can generate a representation more suitable for a semantic feature of the text message. For example, computing device 110 may adjust the initial parameter of the text feature representation model by using the masked language model (MLM) as a training task to obtain the trained text feature representation model (for example, capable of being used in method 200). Computing device 110 may also adjust the initial parameter by using other unsupervised learning tasks.

Method 300 provides a constructing method of the text feature representation model used by the present disclosure. Method 300 uses two stages of training to construct the text feature representation model for service request messages. In this way, on the one hand, pre-training can be performed in a pre-training stage with a larger general corpus, thereby avoiding the problem that the amount of data of the historical request messages is insufficient to train the text representation model from beginning.

On the other hand, as there is a difference in text features between the request message and the general corpus, adjustment is made on the basis of a pre-trained initial model by using the historical request messages as training data, which can make the finally obtained model more suitable for representing the historical request messages. In an explanatory simulated example, computing device 110 uses a 16 G general corpus to pre-train a RoBERTa-based language representation model, then uses a 94 M request message as training data to fine-tune the pre-trained model, and uses a set of request messages as a test set to evaluate a result model of two stages. The fine-tuning training task is executed for one epoch for each GPU by setting a sample batch size to 4. In this simulated example, compared with the pre-trained model, the fine-tuned model indicates that perplexity of the test set can significantly drop from 58.3553 to 5.2453, which indicates that the quality of representing the request message by the fine-tuned model is significantly improved.

In some embodiments, computing device 110 may also train the reference recommendation model. FIG. 4 shows example workflow 400 for training a reference recommendation model according to some embodiments of the present disclosure. Example workflow 400 can be executed by, for example, computing device 110 shown in FIG. 1, and the trained reference recommendation model can be used, for example, at block 230 of method 200. It should be understood that example workflow 400 is shown for illustrative purposes only, actions in the embodiments described by example workflow 400 may be combined in a different way from the described way, and/or combined with embodiments described by other parts of the present disclosure, and the scope of the present disclosure is not limited in this regard. Workflow 400 is described in detail below in conjunction with example environment 100 of FIG. 1.

In some embodiments, computing device 110 may use a subset in the set of historical request messages for training the text feature representation model to train the reference recommended model, and the historical request messages in the subset have been associated with the entries in knowledge base 140 (for example, added with tags). In some such embodiments, computing device 110 may extract the subset from a record of the set of historical request messages, and tags corresponding to the request messages in the subset. The tag corresponding to each request message in the subset indicates an entry associated with the request message in the knowledge base. Then, computing device 110 may execute the supervised training task by using the subset and the tags corresponding to the entries in the subset to determine a parameter of the reference recommendation model. The subset and the corresponding tags are shown as request messages 405 with tags in FIG. 4.

In some embodiments, computing device 110 may determine a set of text feature representations of messages in the subset based on trained text feature representation model 410 (for example, according to method 300). For example, computing device 110 may input request message 405 into trained text feature representation model 410 so as to output a text feature representation. Then, computing device 110 may execute the supervised training task by using the set of text feature representations determined by trained text feature representation model 400 and the tag corresponding to each text feature representation (based on the corresponding request message) so as to determine the parameter of the reference recommendation model.

In some such embodiments, computing device 110 may construct the text feature representation model into a classifier, and construct the supervised training task as a text classification problem, that is, a problem of predicting its category (indicated by the tag) based on the text feature representation. Computing device 110 may use part of the subset as request message training set 405 to execute the task on the reference recommendation model, for example, shown by reference recommendation model training 420. Computing device 110 may also use another part of the subset as request message test set 425 to evaluate a training result, for example, shown by reference recommendation model evaluation 430. Through this training, computing device 110 can make trained reference recommendation model 435 learn the association manner between text feature representations and tags (then, the association manner between request messages and entries in knowledge base 140), so as to be used to relatively accurately recommend entries in knowledge base 140 to the request messages in combination with the text feature representation model. For example, for a text message, the trained reference recommendation model can recommend entries most likely associated with the message and indicate the probabilities of association of these entries with the request message.

In some other embodiments, computing device 110 may also connect the trained text feature representation model (for example, according to method 300) and the reference recommendation model, so that the text feature representations output by the text feature representation model are to be input into the reference recommendation model. On this basis, computing device 110 may execute, on the text feature representation model and the reference recommendation model which are connected, the supervised training task of determining tags based on request messages by using the above historical request message subset and corresponding tags. Computing device 110 may execute the task in a way similar to the above way, so that the combined model learns the association manner between request messages and entries in knowledge base 140 so as to be used to recommend entries in knowledge base 140 to request messages.

In some such embodiments, through this training process, computing device 110 may further adjust the parameter of the text feature representation model in addition to determining the parameter of the reference recommendation model. For example, computing device 110 may not fix the parameter of the text feature representation model while executing the training task on the combined model. In other words, unlike FIG. 4 where trained text feature representation model 410 is shown as a functional block providing an input to other functional blocks, the embodiment also regards the text feature representation model as an object to be further trained in this stage of training. In this way, the trained model can be more adapted to reference knowledge recommendation for request messages.

FIG. 5 shows a schematic block diagram of device 500 that may be configured to implement embodiments of the present disclosure. Device 500 may be the device or apparatus described in the embodiments of the present disclosure, for example, computing device 110. As shown in FIG. 5, device 500 includes central processing unit (CPU) 501 which may execute various appropriate actions and processing according to computer program instructions stored in read-only memory (ROM) 502 or computer program instructions loaded from storage unit 508 to random access memory (RAM) 503. Various programs and data needed for operations of device 500 may also be stored in RAM 503. CPU 501, ROM 502, and RAM 503 are connected to one another through bus 504. Input/output (I/O) interface 505 is also connected to bus 504. Although not shown in FIG. 5, device 500 may also include a co-processor.

A plurality of components in device 500 are connected to I/O interface 505, including: input unit 506, such as a keyboard and a mouse; output unit 507, such as various types of displays and speakers; storage unit 508, such as a magnetic disk and an optical disc; and communication unit 509, such as a network card, a modem, and a wireless communication transceiver. Communication unit 509 allows device 500 to exchange information/data with other devices via a computer network, such as the Internet, and/or various telecommunication networks.

The various methods or processes described above may be executed by processing unit 501. For example, in some embodiments, the method may be implemented as a computer software program that is tangibly included in a machine-readable medium, such as storage unit 508. In some embodiments, part of or all the computer program may be loaded and/or installed to device 500 via ROM 502 and/or communication unit 509. When the computer program is loaded into RAM 503 and executed by CPU 501, one or more steps or actions of the method or process described above may be executed.

In some embodiments, the method and process described above may be implemented as a computer program product. The computer program product may include a computer-readable storage medium on which computer-readable program instructions for executing various aspects of the present disclosure are loaded.

The computer-readable storage medium may be a tangible device that may retain and store instructions used by an instruction-executing device. For example, the computer-readable storage medium may be, but not limited to, an electrical storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (for example, light pulses through fiber-optic cables), or electrical signals transmitted through electrical wires.

The computer-readable program instructions described herein may be downloaded from a computer-readable storage medium to various computing/processing devices, or downloaded to an external computer or an external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for executing the operations of the present disclosure may be assembly instructions, Instruction Set Architecture (ISA) instructions, machine instructions, machine-related instructions, microcode, firmware instructions, status setting data, or source code or object code written in any combination of one or more programming languages, and the programming languages include object-oriented programming languages as well as conventional procedural programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

These computer-readable program instructions may be provided to a processing unit of a general-purpose computer, a special-purpose computer, or other programmable data processing apparatuses, thereby producing a machine, such that these instructions, when executed by the processing unit of the computer or the other programmable data processing apparatuses, produce an apparatus for implementing functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded to a computer, other programmable data processing apparatuses, or other devices, so that a series of operating steps may be executed on the computer, the other programmable data processing apparatuses, or the other devices to produce a computer-implemented process, such that the instructions executed on the computer, the other programmable data processing apparatuses, or the other devices may implement the functions/actions specified in one or more blocks in the flow charts and/or block diagrams.

The flow charts and block diagrams in the drawings illustrate the architectures, functions, and operations of possible implementations of the device, method, and computer program product according to a plurality of embodiments of the present disclosure. In this regard, each block in the flow charts or block diagrams may represent a module, a program segment, or part of an instruction, and the module, program segment, or part of the instruction includes one or more executable instructions for implementing specified logical functions. In some alternative implementations, functions marked in the blocks may also occur in a sequence different from that marked in the accompanying drawings. For example, two consecutive blocks may in fact be executed substantially concurrently, and sometimes they may also be executed in a reverse sequence, depending on the functions involved. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

Various embodiments of the present disclosure have been described above. The foregoing description is illustrative rather than exhaustive, and is not limited to the disclosed various embodiments. Numerous modifications and alterations are apparent to persons of ordinary skill in the art without departing from the scope and spirit of the illustrated embodiments. The selection of terms as used herein is intended to best explain the principles and practical applications of the various embodiments or the technical improvements to technologies on the market, or to enable other persons of ordinary skill in the art to understand the various embodiments disclosed here.

1. A method for processing a request message, comprising:
receiving a request message from a user, wherein the request message describes a user request to be processed;
determining a text feature representation of the request message by using a trained text feature representation model, wherein the text feature representation model is trained by using a general corpus and a set of historical request messages; and
determining, based on the text feature representation, one or more entries associated with the request message in a knowledge base by using a trained reference recommendation model, wherein the knowledge base includes a plurality of entries of reference knowledge for processing user requests, the reference recommendation model is trained by using a subset of the set of historical request messages, and the request messages in the subset have been associated with the entries in the knowledge base.

2. The method according to claim 1, further comprising training the text feature representation model, wherein training the text feature representation model comprises:
determining an initial parameter of the text feature representation model by using the general corpus and executing a first unsupervised training task on the text feature representation model.

3. The method according to claim 2, wherein training the text feature representation model further comprises:
extracting the set of historical request messages from a record of the set of historical request messages; and
adjusting the initial parameter of the text feature representation model by using the set of request messages and executing a second unsupervised training task on the text feature representation model so as to obtain the trained text feature representation model.

4. The method according to claim 1, further comprising training the reference recommendation model, wherein training the reference recommendation model comprises:
extracting the subset from a record of the set of historical request messages, and tags corresponding to the request messages in the subset, wherein a corresponding tag of a corresponding request message indicates entries in the knowledge base associated with the corresponding request message; and
training the reference recommendation model by using the subset and the tags.

5. The method according to claim 4, wherein training the reference recommendation model by using the subset and the tags comprises:
determining a set of text feature representations of the subset based on the trained text feature representation model; and
determining a parameter of the reference recommendation model by using the set of text feature representations and the tags and executing, on the reference recommendation model, a first supervised training task of determining tags based on text feature representations.

6. The method according to claim 4, wherein training the reference recommendation model by using the subset and the tags comprises:
connecting the trained text feature representation model with the reference recommendation model, so that text feature representations output by the text feature representation model are to be input into the reference recommendation model; and
adjusting the parameter of the text feature representation model and determining the parameter of the reference recommendation model by using the subset and the tags and executing, on the connected text feature representation model and reference recommendation model, a second supervised training task of determining tags based on request messages.

7. The method according to claim 1, further comprising:
presenting the one or more entries via a user interface;
receiving a selection for entries in the knowledge base via the user interface;
storing a record of the request and the selected entries in an associated manner; and
adjusting the reference recommendation model by using the association between the record and the entries.

8. The method according to claim 1, further comprising:
receiving a new entry that should be added into the knowledge base via a user interface;
storing a record of the request and the new entry in an associated manner; and
adjusting the reference recommendation model by using the association between the record and the new entry.

9. An electronic device, comprising:
a processor; and
a memory coupled to the processor, wherein the memory has instructions stored therein which, when executed by the processor, cause the device to execute actions comprising:
receiving a request message from a user, wherein the request message describes a user request to be processed;
determining a text feature representation of the request message by using a trained text feature representation model, wherein the text feature representation model is trained by using a general corpus and a set of historical request messages; and
determining, based on the text feature representation, one or more entries associated with the request message in a knowledge base by using a trained reference recommendation model, wherein the knowledge base includes a plurality of entries of reference knowledge for processing user requests, the reference recommendation model is trained by using a subset of the set of historical request messages, and the request messages in the subset have been associated with the entries in the knowledge base.

10. The device according to claim 9, further comprising training the text feature representation model, wherein training the text feature representation model comprises:
determining an initial parameter of the text feature representation model by using the general corpus and executing a first unsupervised training task on the text feature representation model.

11. The device according to claim 10, wherein training the text feature representation model further comprises:
extracting the set of historical request messages from a record of the set of historical request messages; and
adjusting the initial parameter of the text feature representation model by using the set of request messages and executing a second unsupervised training task on the text feature representation model so as to obtain the trained text feature representation model.

12. The device according to claim 9, wherein the actions further comprise training the reference recommendation model, and training the reference recommendation model comprises:
extracting the subset from a record of the set of historical request messages, and tags corresponding to the request messages in the subset, wherein a corresponding tag of a corresponding request message indicates entries in the knowledge base associated with the corresponding request message; and
training the reference recommendation model by using the subset and the tags.

13. The device according to claim 12, wherein training the reference recommendation model by using the subset and the tags comprises:
determining a set of text feature representations of the subset based on the trained text feature representation model; and
determining a parameter of the reference recommendation model by using the set of text feature representations and the tags and executing, on the reference recommendation model, a first supervised training task of determining tags based on text feature representations.

14. The device according to claim 12, wherein training the reference recommendation model by using the subset and the tags comprises:
connecting the trained text feature representation model with the reference recommendation model, so that text feature representations output by the text feature representation model are to be input into the reference recommendation model; and
adjusting the parameter of the text feature representation model and determining the parameter of the reference recommendation model by using the subset and the tags and executing, on the connected text feature representation model and reference recommendation model, a second supervised training task of determining tags based on request messages.

15. The device according to claim 9, wherein the actions further comprise:
presenting the one or more entries via a user interface;
receiving a selection for entries in the knowledge base via the user interface;
storing a record of the request and the selected entries in an associated manner; and
adjusting the reference recommendation model by using the association between the record and the entries.

16. The device according to claim 9, wherein the actions further comprise:
receiving a new entry that should be added into the knowledge base via a user interface;
storing a record of the request and the new entry in an associated manner; and
adjusting the reference recommendation model by using the association between the record and the new entry.

17. A computer program product tangibly stored on a computer-readable medium and comprising machine-executable instructions, wherein the machine-executable instructions, when executed, cause a machine to:
receive a request message from a user, wherein the request message describes a user request to be processed;
determine a text feature representation of the request message by using a trained text feature representation model, wherein the text feature representation model is trained by using a general corpus and a set of historical request messages; and
determine, based on the text feature representation, one or more entries associated with the request message in a knowledge base by using a trained reference recommendation model, wherein the knowledge base includes a plurality of entries of reference knowledge for processing user requests, the reference recommendation model is trained by using a subset of the set of historical request messages, and the request messages in the subset have been associated with the entries in the knowledge base.

18. The computer program product of claim 17, wherein the machine-executable instructions are further configured to train the text feature representation model, wherein training the text feature representation model is further configured to:
determine an initial parameter of the text feature representation model by using the general corpus and executing a first unsupervised training task on the text feature representation model.

19. The computer program product of claim 18, wherein the machine-executable instructions configured to train the text feature representation model are further configured to:
extract the set of historical request messages from a record of the set of historical request messages; and
adjust the initial parameter of the text feature representation model by using the set of request messages and executing a second unsupervised training task on the text feature representation model so as to obtain the trained text feature representation model.

20. The computer program product of claim 17, wherein the machine-executable instructions are further configured to train the reference recommendation model, wherein training the reference recommendation model is further configured to:
extract the subset from a record of the set of historical request messages, and tags corresponding to the request messages in the subset, wherein a corresponding tag of a corresponding request message indicates entries in the knowledge base associated with the corresponding request message; and
train the reference recommendation model by using the subset and the tags.
